(19) United States
(12) Patent Application Publication
(10) Pub. No.: US 2008/0105710 A1
(43) Pub. Date: May 8, 2008

(54) GLUE DISPENSER

(75) Inventor: TAI-CHERNG YU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/845,727

(22) Filed: Aug. 27, 2007

(30) Foreign Application Priority Data
Nov. 8, 2006 (CN) 200610063530.6

(51) Int. Cl. B67D 5/64

(52) U.S. Cl. 222/160

(57) ABSTRACT

A glue dispenser used in lens module assembly according to a preferred embodiment includes: a container configured for supplying a glue; a needle fluidly communicating with the container; a frame with the container mounted thereon and at least one elastic member arranged between the frame and the container thereby rendering the container movable along a lengthwise direction of the needle with respect to the frame.

### BACKGROUND

1. Technical Field

The present invention relates generally to dispensers for glue, adhesive, or the like.

2. Description of Related Art

Nowadays, lens modules are widely employed in camera systems and mobile phones for image capturing. Generally, a lens module includes a lens barrel, at least a lens group, a spacer, and a filter (e.g., IR-cut filter). The lens group, the spacer and the filter are received in the lens barrel and arranged along an optical axis thereof, in that order from an object side to an image side of the lens module. The filter is bonded with the spacer via a bonding layer formed of a glue/adhesive. The bonding layer is usually formed on a bonded-side of the spacer via a dispensing process.

Referring to FIG. 5, a typical dispenser 10 employed in above-mentioned dispersing process usually includes a base holder 11, a container 12, a nozzle 13 and a holding member 15. The holding member 15 is fixed on the base holder 11 and configured for holding the container 12, the container 12 is fixed on the holding member 15 by a screw bolt 14, and the nozzle 13 is held in communication with the container 12 and is configured for allowing pressurized glue to flow out therethrough. Generally, in the dispensing process, the nozzle 13 is accurately positioned and then dispenses glue at the bonded-side of the spacer in a manner to facilitate a joining together of the lens barrel and spacer, in order to prevent the filter (or the filter and the spacer together) from peeling or otherwise becoming dislodged from the lens module. However, in a practical dispensing process, that the nozzle 13 might rigidly contact with the spacer, or other optical elements, but the nozzle 13 cannot retract, so that the nozzle 13 is easily damaged.

What is needed, therefore, is a glue dispenser could avoid damage to a nozzle in a dispensing processes.

### SUMMARY

A preferred embodiment provides a dispenser for glue/adhesive. The glue dispenser includes: a container configured for supplying a glue; a needle fluidly communicating with the container; a frame with the container mounted thereon and at least one elastic member arranged between the frame and the container thereby rendering the container movable with respect to the frame along a lengthwise direction of the needle with respect to the frame.

Other advantages and novel features will become more apparent from the following detailed description of preferred embodiment when taken in conjunction with the accompanying drawings.

### BRIEF DESCRIPTION OF THE DRAWINGS

Many aspects of the present glue dispenser can be better understood with reference to the following drawings. The components in the drawings are not necessarily drawn to scale, the emphasis instead being placed upon clearly illustrating the principles of the present glue dispenser. Moreover, in the drawings, like reference numerals designate corresponding parts throughout the several views.

FIG. 1 is an isometric view of a glue dispenser according to a first preferred embodiment, the glue dispenser including an annular element;

FIG. 2 is an isometric view of the annular element of the glue dispenser in FIG. 1;

FIG. 3 is an isometric view of a glue dispenser according to a second preferred embodiment;

FIG. 4 is an isometric view of a glue dispenser according to a third preferred embodiment; and

FIG. 5 is a schematic view of a conventional glue dispenser.

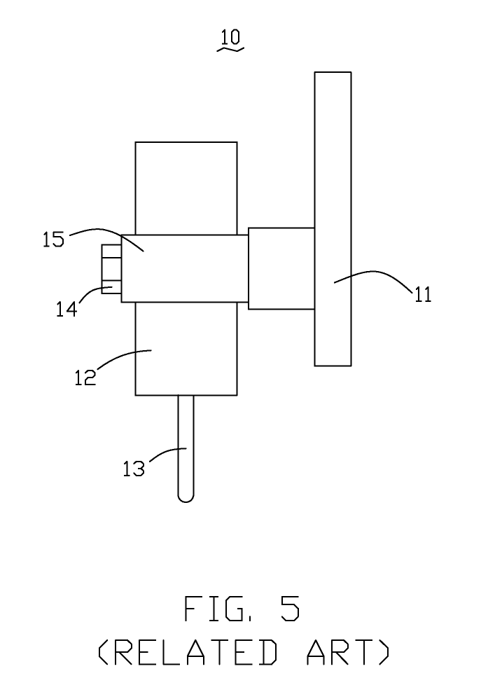

The exemplifications set out herein illustrate various preferred embodiments, in various forms, and such exemplifications are not to be construed as limiting the scope of the present glue dispenser in any manner.

### DETAILED DESCRIPTION

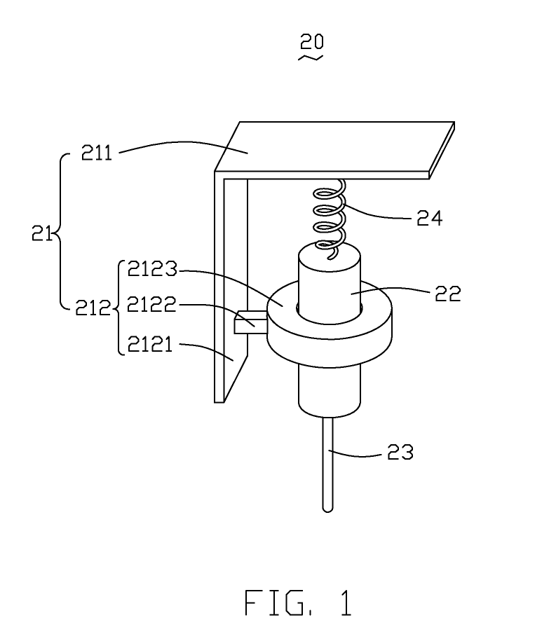

Referring to FIG. 1, a glue dispenser 20 for use in manufacturing a lens module assembly in accordance with a first preferred embodiment is shown. The present glue dispenser 20 includes a frame 21, a container 22, a needle 23, and an elastic element 24.

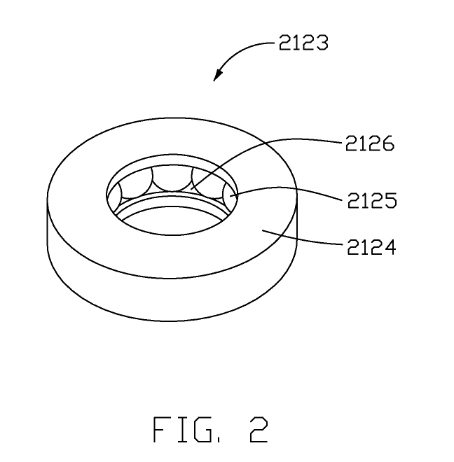

The frame 21 includes a support 211 and a holding part 212. The support 211 is located at the top of the holding part 212, and is plate-shaped. The holding part 212 includes a holding base 2121, a holding arm 2122 and a container guiding member 2123. The holding base 2121 is connected with the support 211 and extending along a direction substantially perpendicular to and away from the support 211. The container guiding member 2123 is held on the holding base 2121 by the holding arm 2122. The holding arm 2122 extends along a direction substantially parallel to a lengthwise direction of the support 211, and one end thereof is connected with the holding base 2121 and the other end thereof is connected with the container guiding member 2123. Alternatively, the container guiding member 2123 could be fixed on the holding base 2121 directly without the need for the holding arm 2122. Furthermore, the holding base 2121 can be integrally formed with the support 211. The container guiding member 2123 surrounds the container 22. Referring to FIG. 2, the container guiding member 2123 includes a ring-shaped race 2124 having a raceway 2126 and a number of rolling elements 2125 received in the raceway 2126. A channel 2128 is defined in the middle of the ring-shaped race 2124 and configured for guiding the container 22 to move in the lengthwise direction of the needle 23. The rolling elements 2125 are accommodated in the raceway 2126 uniformly and rollably. The container 22 extends through the channel 2128 of the container guiding member 2123. The container 22 comes into contact with the rolling element 2125, and is held so as to be movable only along the central axis of the container guiding member 2123. The central axis of the container guiding member 2123 extends in a same direction as that of the lengthwise direction of the needle 23. Preferably, some anti-friction materials can be applied between the container 22 and the rolling elements 2125, so as to allow the container 22 to move more easily. The container guiding member 2123 and the container 22 are made of a wear resistant material such as rigid plastic, or iron, etc.

The container 22 can be, e.g., a hollow cylinder, in shape. The container 22 is configured (i.e., structured and arranged) for supplying a pressurized glue/adhesive. A propelling force/pressure for the pressurized glue/adhesive could be provided by a mechanical pressure or an atmospheric pressure.

The needle 23 extends from one end of the container 22 and is fluidly communicated therewith. The needle 23 is located depart away from the support 211.

The elastic element 24 is arranged between the frame 21 and the container 22 thereby rendering the container 22 movable along a lengthwise direction of the needle 23, with respect to the frame 21. The elastic element 24 is attached to an end of the container 22 that faces away from the needle 23. The elastic element 24 can be a spring coil or an elastoplastic member etc. The elastic element 24 can be connected with the support 211 and the container 22 by cementation, adhesive or by metallurgical means, etc.

When the glue dispenser 20 is employed in gluing components of a lens module assembly and the needle 23 is rigidly contacted with the lens, spacer, filter or other optical elements, or the lens barrel, the elastic element 24 deform and produce an elastic force, under an effect of the elastic force, the container 22 and the needle 23 then moves along the central axis of the container guiding member 2123 and close to the support 211 so as to release the force applied to the needle 23 from the optical elements, thus avoiding damage to the needle 23.

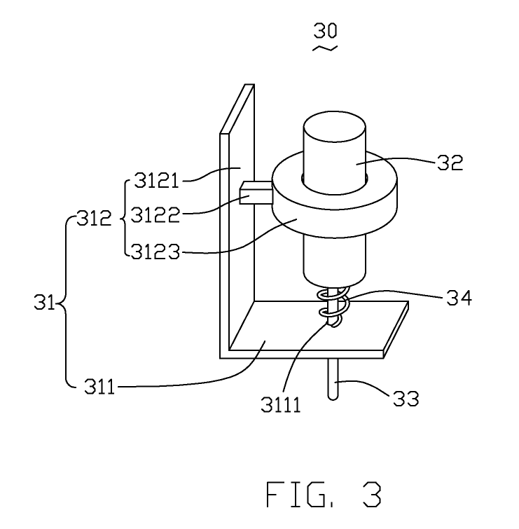

Referring to FIG. 3, a glue dispenser 30 in accordance with a second preferred embodiment is shown. The present glue dispenser 30 is similar with the glue dispenser 20; the glue dispenser 30 includes a frame 31, a container 32, a needle 33, and an elastic element 34.

The frame 31 includes a support 311 and a holding part 312. The support 311 is located at the bottom of the holding part 312, and is plate-shaped. A through hole 3111 is defined in the support 311. The holding part 312 includes a holding base 3121, a holding arm 3122 and a container guiding member 3123. The holding base 3121 is connected with the support 311 and extending along a direction substantially perpendicular to and away from the support 311. The holding arm 3122 extends along a direction substantially parallel to a lengthwise direction of the support 311 and one end thereof is connected with the holding base 3121 and the other end thereof is connected with the container guiding member 3123. The container guiding member 3123 is the same as the container guiding member 2123.

The needle 33 extends from one end of the container 32 and is fluidly communicated therewith. The needle 33 is located close to the support 311, and penetrates the through hole 3111 of the support 311.

The elastic element 34 surrounds the needle 33. In the illustrated embodiment, a central axis of the elastic element 34 extends in a direction essentially identical to that of the lengthwise direction of the needle 33, and the container 32 is movable along the lengthwise direction of the needle 33 with respect to the frame 21.

When the glue dispenser 30 is employed in gluing components of a lens module assembly and the needle 33 is rigidly contacted with the lens, spacer, filter or other optical elements, or the lens barrel, the elastic element 34 deform and produce an elastic force, under an effect of the elastic force, the needle 33 and the container 32 then moves along the central axis of the container guiding member 3123 and far away from the support 311 so as to release the force applied to the needle 33 from the optical elements, thus avoiding damaging the needle 33. Because of the central axis of the elastic element 34 coincides with a central axis of container guiding member 3123, the elastic element 34 can be deformed uniformly.

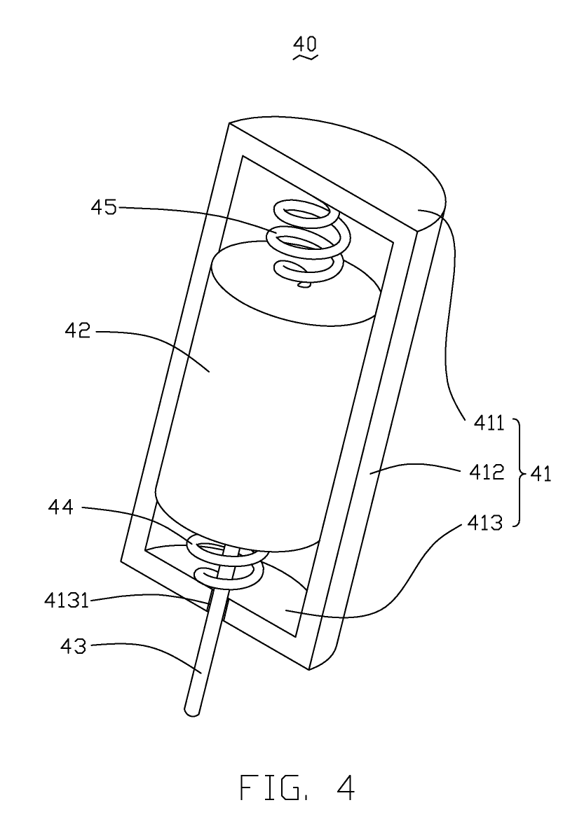

Referring to FIG. 4, a glue dispenser 40 in accordance with a third preferred embodiment is shown. The present glue dispenser 40 includes a frame 41, a container 42, a needle 43, a first elastic element 44 and a second elastic element 45. The frame 41 is semi-cylindrical shaped and includes a semicircular first base plate 411, a holding part 412, and a semicircular second base plate 413. The first base plate 411 and the second base plate 413 are shaped and positioned so as to be symmetrical to each other and located at opposite ends of the holding part 412, and the holding part 412 is connected with them perpendicularly and respectively. In this way, the first base plate 411, the holding part 412, and the second base plate 413 cooperatively define a channel for receiving the container 42 therein. The second base plate 413 defines a through hole 4131 with a diameter slightly larger than a diameter of the needle 43.

At least half of the container 42 is accommodated in the channel 46, an inner diameter of the frame 41 is slightly larger than an external diameter of the container 42, in the illustrated embodiment, the inner diameter of the frame 41 is 0˜3 millimeters larger than the external diameter of the container 42. The needle 43 extends from one end of the container 42 and is fluidly communicated therewith. The needle 43 is positioned adjacent to the second base plate 413, and extends through the through hole 4131. The first elastic element 44 and the second elastic element 45 are received in the frame 41 and arranged at opposite ends of the container 42, and the first elastic element 44 surrounds the needle 43. A central axis of the first elastic element 44 and the second elastic element 45 extends in a same direction as that of a central axis of the container 42. A sum of length of the container 42, the first elastic element 44 and the second elastic element 45 may be smaller than a distance between the first base plate 411 and the second base plate 413. In the illustrated embodiment, the sum of length of the container 42, the first elastic element 44 and the second elastic element 45 is 0˜10 millimeters smaller than distance between the first base plate 411 and the second base plate 413.

When the glue dispenser 40 is employed in gluing components of a lens module assembly and the needle 43 is rigidly contacted with the lens, spacer, filter or other optical elements, or the lens barrel, the first elastic element 44 and the second elastic element 45 both deform and produce an elastic force, under an effect of the elastic force, the container 42 and the needle 43 then moves along the central axis of the container 42 and close to the first base plate 411 so as to release the force applied to the needle 43 from the optical elements, thus avoiding damage to the needle 43. Because of the central axis of the first elastic element 44 and the second elastic element 45 extends in a same direction as that of central axis of the container 42, the first elastic element 44 and the second elastic element 45 can be deformed uniformly. Preferably, some anti-friction materials can be inserted between the container 42 and the holding part 412, so as to allow the container 42 to move easily.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A glue dispenser, comprising:
a container configured for supplying a glue;
a needle fluidly communicating with the container;
a frame with the container mounted thereon and
at least one elastic member arranged between the frame and the container thereby rendering the container movable with respect to the frame along a lengthwise direction of the needle.

2. The glue dispenser of claim 1, wherein the frame comprises a container guiding member surrounding the container, the container guiding member having a channel configured for guiding the container to move in the lengthwise direction of the needle.

3. The glue dispenser of claim 2, wherein the container guiding member comprises a ring-shaped race having a raceway, a plurality of rolling elements received in the raceway, the container extending through the channel of the container guiding member and coming into contact with the rolling elements.

4. The glue dispenser of claim 3, wherein a central axis of the elastic element extends in a same direction as that of the lengthwise direction of the needle.

5. The glue dispenser of claim 2, wherein the container is at least partly received in the channel of the container guiding member.

6. The glue dispenser of claim 5, wherein the at least on elastic member comprises a first elastic element and a second elastic element, the first and second elastic elements arranged at opposite ends of the container.

7. The glue dispenser of claim 6, wherein the first elastic element and the second elastic element are received in the container guiding member.

8. The glue dispenser of claim 1, wherein the at least one elastic member surrounds the needle.

9. The glue dispenser of claim 8, wherein the frame comprises a support with a through hole defined therein, the needle extending through the through hole, the elastic element being arranged between the container and the support.

10. The glue dispenser of claim 1, wherein the at least one elastic member is attached to an end of the container which faces away from the needle.

11. The glue dispenser of claim 1, wherein the at least one elastic element is a spring coil or an elastoplastic member.
